(19) United States
(12) Patent Application Publication
(10) Pub. No.: US 2016/0341578 A1
(43) Pub. Date: Nov. 24, 2016

(54) APPARATUS-ASSISTED SENSOR DATA COLLECTION

(71) Applicant: QUALCOMM Incorporated, San Diego, CA (US)

(72) Inventors: Edwin Chongwoo Park, San Diego, CA (US); Yih-Hao Lin, San Diego, CA (US); Samir Salib Soliman, Poway, CA (US)

(21) Appl. No.: 14/720,492

(22) Filed: May 22, 2015

(51) Int. Cl. G01D 11/30; H02J 13/00

(52) U.S. Cl. CPC G01D 11/30; H02J 13/0017

(57) ABSTRACT

The disclosure provides various methods and apparatuses for obtaining data. A method includes positioning the apparatus in proximity to a point of interest (POI), wherein an extension portion of the apparatus extends towards the POI. The method also includes providing power to a sensor via the extension portion, and receiving data from the sensor via the extension portion. The sensor may be detached from or attached to the apparatus. The data may be received via a wired or wireless connection. The power may be provided via a wired or wireless connection. The method may also include moving the extension portion further towards the POI after positioning the apparatus in proximity to the POI. The method may also include retracting the extension portion after receiving the sensor data or after expiration of a time period during which no data is received from the sensor. The apparatus may be an autonomous drone.

### TECHNICAL FIELD

The present disclosure relates generally to data collection and, more particularly, to apparatus-assisted sensor data collection.

### BACKGROUND

Conventional systems for measuring environmental conditions may utilize various sensors. For example, sensors may measure temperature, moisture, radioactivity, luminosity, pressure, etc. In some applications, these sensors may be deployed throughout a large geographic area (e.g., tens or hundreds of acres). Some conventional systems may utilize wires for providing power to the sensors and for receiving data from the sensors. However, deploying such a system across a large geographic area may involve substantial material costs and/or labor demands for maintenance and repair. Other conventional systems may utilize batteries to provide power to the sensors. Batteries sometimes need to be replaced and have the potential to leak or corrode. Some other conventional systems may utilize solar cells to provide power to the sensors. Solar cells may receive limited sunlight during cloudy, rainy, or snowy days. Accordingly, conventional systems can benefit from improvements that enhance sensor power supply and sensor data collection.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In an aspect, the present disclosure provides a method of obtaining data. The method includes positioning an apparatus in proximity to a point of interest (POI), wherein an extension portion of the apparatus extends towards the POI. The method also includes providing power to a sensor via the extension portion of the apparatus, and receiving data from the sensor via the extension portion of the apparatus.

In another aspect, the present disclosure provides an apparatus for obtaining data. The apparatus includes a transceiver, a memory, and at least one processor communicatively coupled to the transceiver and the memory. The at least one processor is configured to determine to position the apparatus in proximity to a POI, wherein an extension portion of the apparatus extends towards the POI. The at least one processor is also configured to utilize the transceiver to receive data from a sensor via the extension portion of the apparatus. In some configurations, the apparatus also includes a power source communicatively coupled to the at least one processor. In such configurations, the at least one processor is also configured to utilize the power source to provide power to the sensor via the extension portion of the apparatus. In some other configurations, the power source may be separate from the apparatus.

In yet another aspect, the present disclosure provides another apparatus for obtaining data. The apparatus includes a processing system. The apparatus also includes a motor for positioning the apparatus in proximity to a POI. The apparatus also includes an extension portion extending towards the POI, and the extension portion includes a power line configured for providing power to a distal part of the extension portion, and a communication line configured for communicating data from the distal part of the extension portion to the processing system. In some configurations, the apparatus also includes a power source. In some other configurations, the power source may be separate from the apparatus.

In a further aspect, the present disclosure provides yet another apparatus for obtaining data. The apparatus includes means for processing. The apparatus also includes means for positioning the apparatus in proximity to a POI. The apparatus also includes means for extending towards the POI. The means for extending towards the POI includes a power line (or a power transfer, which may be wired and/or wireless) configured for providing power to a distal part of the means for extending towards the POI, and a communication line configured for communicating data from the distal part of the means for extending towards the POI to the means for processing. In some configurations, the apparatus also include means of powering. In some other configurations, the means for powering may be separate from the apparatus.

These and other aspects of the invention will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a diagram illustrating a first example of an apparatus moving to a position in proximity to a point of interest (POI).

FIG. 2 is a diagram illustrating a first example of an apparatus with an extension portion extending towards the POI.

FIG. 3 is a diagram illustrating a first example of an apparatus with an extension portion retracting away from the POI.

FIG. 4 is a diagram illustrating a second example of an apparatus moving to a position in proximity to POI.

FIG. 5 is a diagram illustrating a second example of an apparatus with an extension portion extending towards the POI.

FIG. 6 is a diagram illustrating a second example of an apparatus with an extension portion retracting away from the POI.

FIG. 7 is a diagram illustrating an example of various methods and/or processes operable at an apparatus.

FIG. 8 is a diagram illustrating an example of a hardware implementation of a processing system of an apparatus.

### DETAILED DESCRIPTION OF SOME EMBODIMENTS

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

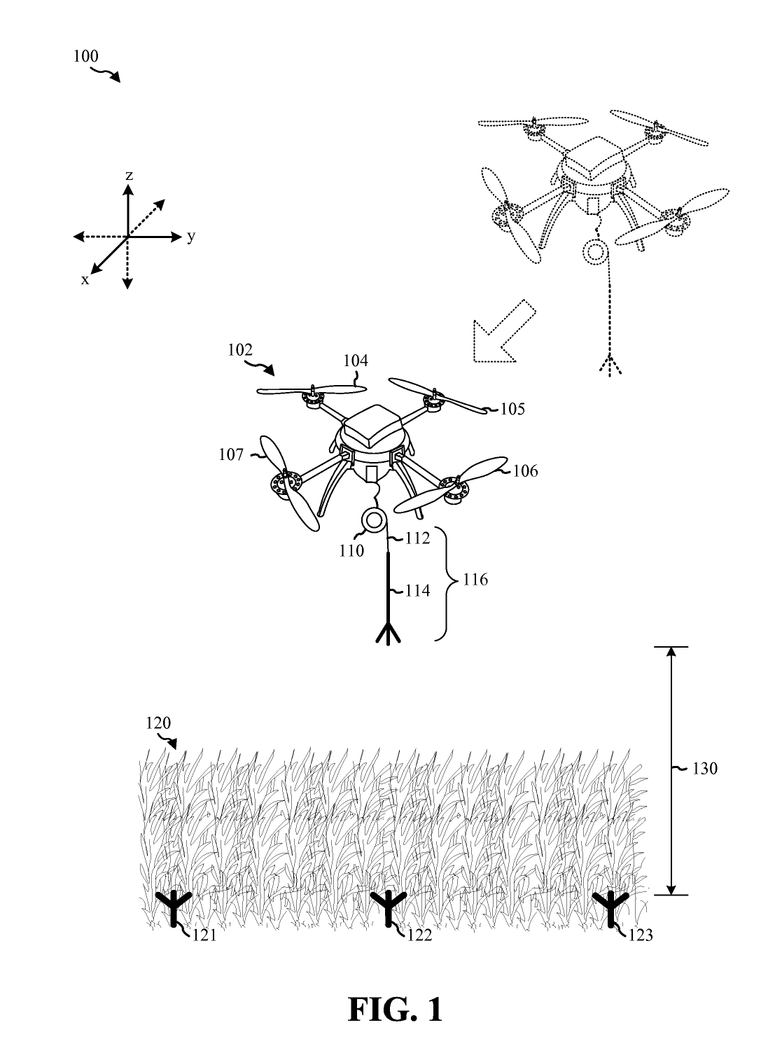

FIG. 1 is a diagram 100 illustrating an example of an apparatus 102 moving to a position in proximity to a point of interest (POI). The term ‘POI’ may refer to a specific point, region, location, and/or geography. The POI may be identified or defined using various parameters without deviating from the scope of the present disclosure. For example, the POI may be identified or defined by a longitude and latitude coordinate, an elevation or altitude coordinate, an address, a beacon, a sensor, a stationary target, a fixed location, an anchored object, a moving target, a changing location, a mobile object, and/or various other suitable references. Such parameters may be utilized by various positioning and/or geolocation technologies without deviating from the scope of the present location. For example, such parameters may be utilized by a Global Positioning System (GPS), a Global Information System (GIS), a satellite system, a signal triangulation system, and/or various other suitable positioning and/or geolocation systems. In some configurations, the POI may correspond to the location of an object. One of ordinary skill in the art will understand that the POI may correspond to any object without deviating from the scope of the present disclosure. As a non-limiting example, FIG. 1 illustrates that the POI corresponds to the location of a sensor 122.

The apparatus 102 may be any device that is configured to move to a position that is in proximity to an object (e.g., the sensor 122). Movement of the apparatus 102 may be powered by various types of actuators without deviating from the scope of the present disclosure. For example, the apparatus 102 may utilize a hydraulic actuator, a pneumatic actuator, an electric actuator, a thermal actuator, a magnetic actuator, a mechanical actuator, and/or any other suitable type of actuator. An apparatus 102 may be characterized as a drone if the apparatus 102 is configured to move or navigate without continuous human control. Additionally or alternatively, the apparatus 102 may be characterized as a drone if the apparatus 102 is an unmanned apparatus, an unpiloted apparatus, a remotely-piloted apparatus, or any other apparatus that does not have a pilot on board. For purposes of illustration and not limitation, FIG. 1 shows that such an apparatus 102 may be an aerial drone. Generally, an aerial drone is a drone that is configured to move in the air for at least a period of time. However, one of ordinary skill in the art will understand that the apparatus 102 may be a non-aerial drone without deviating from the scope of the present disclosure.

In some configurations, the apparatus 102 may be a terrestrial drone. Generally, a drone may be characterized as terrestrial if the drone is configured to move while in contact with the ground. The terrestrial drone may sometimes be referred to as an unmanned ground vehicle. The terrestrial drone may move utilizing various mechanisms without deviating from the scope of the present disclosure. For example, the terrestrial drone may utilize wheels, rails, hydraulic components, and/or any other suitable type of feature to facilitate movement while in contact with the ground. The terrestrial drone may be configured to move to a position that is in proximity to the object (e.g., the sensor 122) by moving towards that object (e.g., the sensor 122) and positioning itself near that object (e.g., the sensor 122). For example, the terrestrial drone may be configured to be sufficiently close to that object (e.g., the sensor 122) such that its extension portion can reach that object (e.g., the sensor 122).

In some configurations, the apparatus 102 may be an aquatic drone. Generally, a drone may be characterized as aquatic if the drone is configured to move while buoyant on water or at least partially submerged under water for at least a period of time. For example, the aquatic drone may be submersible under water (e.g., a submarine), a buoyant vessel (e.g., a boat, a raft, etc.), or any other apparatus configured to move while buoyant on water or at least partially submerged under water for at least a period of time. The aquatic drone may move utilizing propellers, rudders, and/or any other suitable mechanisms of navigating on and/or under water. The aquatic drone may be configured to move to a position that is in proximity to the object by moving towards that object and positioning itself near that object. For example, the aquatic drone may be configured to be sufficiently close to that object such that its extension portion can reach that object.

In some configurations, the apparatus 102 is an autonomous drone, which includes software and/or hardware modules that enables the apparatus 102 to control its own movements without relying upon constant control and navigation instructions from a user. Generally, a drone may be characterized as autonomous if the drone is configured to make one or more decisions utilizing the aforementioned software and/or hardware modules without direct input from a human. For example, an autonomous drone may be configured to locate the POI (e.g., the sensor 122 and/or the location corresponding to the sensor 122) and navigate itself such that it is positioned in proximity to that POI without necessarily being continually piloted by a human.

In certain circumstances, the location of the POI may change from time to time. In some configurations, the apparatus 102 may update, adjust, revise, correct, refine, and/or otherwise calibrate the location of the POI. For example, the apparatus 102 may include various detection mechanisms (e.g., on-board sensors, etc.) that may enable the apparatus 102 to detect a change in the location of the POI. The apparatus 102 may update, adjust, revise, correct, refine, and/or otherwise calibrate the location of the POI from one data collection attempt (e.g., a first ‘run’) to another data collection attempt (e.g., a second ‘run’). Such detection mechanisms may utilize the power measurements of the sensor 122, various triangulation technologies, and/or other techniques for detecting a change in the location of the POI. In some circumstances, a sensor 122 located on, underneath, above, or otherwise near the ground may move, shift, slide, and/or otherwise alter in location from time to time. As applied to non-limiting applications in agriculture, the sensor 122 may shift, move, shift, slide, and/or otherwise alter in location as a result of various factors. Such factors may include: the growth of agricultural plants 120; movement caused by animals contacting the sensor 122; movement of the soil or ground during fertilization, watering, harvesting, and/or other suitable activities; and/or various objects and/or machines contacting the sensor 122. By updating, adjusting, revising, correcting, refining, and/or otherwise calibrating the location of the POI from one data collection attempt (e.g., a first ‘run’) to another data collection attempt (e.g., a second ‘run’), the apparatus 102 can navigate to a location that is relatively closer to the sensor 122 even during changes in the environment affecting the location of the sensor 122.

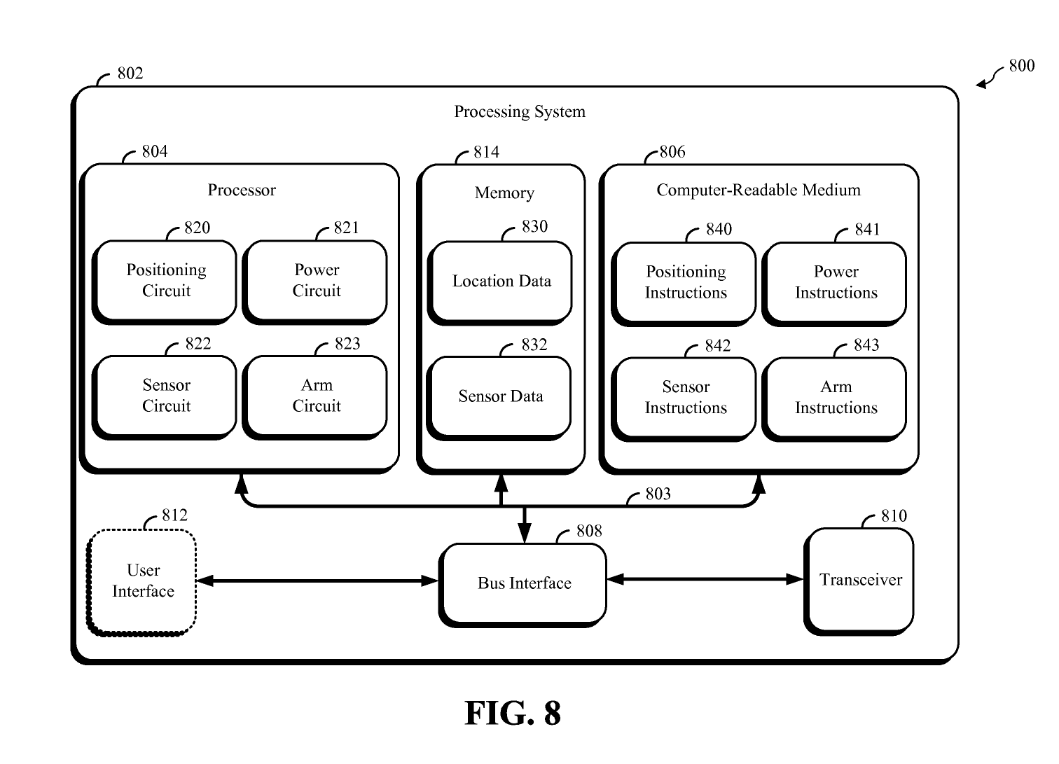

The apparatus 102 may include various components configured for moving the apparatus 102. The apparatus 102 may include a body that includes a processing system. In some configurations, the apparatus 102 includes a power source. Various examples of such power sources are described in greater detail below and therefore will not be repeated. In some other configuration, the power source may be separate from the apparatus. For example, the apparatus 102 may have a wired connection to a power source (e.g., an electric generator, etc.) that is otherwise detached from the apparatus 102. The processing system, which is further described below with reference to FIG. 8, may provide the means for processing various data (e.g., data received from one or more sensors). The power source may be a battery, a solar cell, an electric generator, or any other suitable component that provides power. The power source may provide the means for powering (e.g., means for powering one or more sensors). For purposes of illustration and not limitation, FIG. 1 shows an apparatus 102 that includes a number of propellers 104-107 that assist with the levitation and lateral movement of the apparatus 102. The apparatus 102 may include a motor that controls the movement of the propellers 104-107 and thus the apparatus 102. The motor may be mechanical, electric, or any other suitable type of motor. The motor may provide the means for positioning the apparatus in proximity to a POI. The propellers 104-107 may each be angled in different directions to control the direction of movement of the apparatus in the x-axis and the y-axis. The rotational speed of the propellers 104-107 may affect the degree to which the apparatus 102 ascends, hovers, and descends in the z-axis. One or more of the propellers 104-107 may also affect the yaw, pitch, and/or roll of the apparatus 102. However, one of ordinary skill in the art will understand that the apparatus 102 may include alternative and/or additional components for movement without deviating from the scope of the present disclosure. For example, the apparatus 102 may include a fixed-wing, wherein the fixed-wing may be configured to assist the apparatus 102 with gliding and turning in the air. As another example, the apparatus 102 may be terrestrial and include one of many types of motor engines, which may be powered by gasoline, diesel, bio-fuels, and/or electric power generated by a solar-based power generator and/or a wind-based power generator. One of ordinary skill in the art understands that that apparatus 102 may include various components configured for moving the apparatus 102 without deviating from the scope of the present disclosure.

The apparatus 102 may also include an extension portion 116. The extension portion 116 may exist in various forms, types, configurations, and arrangements without deviating from the scope of the present disclosure. Any description herein with regard to the extension portion 116 of the apparatus 102 is provided for illustrative purposes and shall not be construed excluding alternative forms, types, configurations, and arrangements of the extension portion 116 of the apparatus 102. Generally, the extension portion 116 is characterized as any portion of the apparatus 102 that at least in part extends at any time in any manner beyond the contour of another portion of the apparatus 102. As described in greater detail below, the extension portion 116 may be fixed in length, configuration, angle, direction, and/or other aspects in some configurations and may be adjustable in length, configuration, angle, direction, and/or other aspects in some other configurations. As also described in greater detail below, such ‘extending’ may refer to drawing out, unreeling, unfolding, folding out, angling outward, rotating outward, gliding outward, spiraling outward, unwinding, and/or otherwise moving at least a part of the extension portion 116 towards a particular area (e.g., the POI, such as the sensor 122).

In the non-limiting example illustrated in FIG. 1, the extension portion 116 of the apparatus 102 includes an antenna 114 located at the distal part of a retractable transmission line 112. The retractable transmission line 112 may include a power line configured for providing power from the power source (as described above) of the apparatus 102 to a distal part (e.g., the antenna 114) of the extension portion 116. The retractable transmission line 112 may also include a communication line configured for communicating data from the distal part (e.g., the antenna 114) of the extension portion 116 to the processing system of the apparatus 102.

Although not illustrated in FIG. 1, in some configurations, the extension portion 116 may be a tail located on a distal portion (e.g., an end) of the apparatus 102. Such a tail may be positioned in a downward configuration (e.g., downwards towards the POI, such as the sensor 122). In such a configuration, the tail may not move independent of the apparatus 102. In other words, the tail may not become closer to the POI (e.g., the sensor 122) without the apparatus 102 also becoming closer to the POI (e.g., the sensor 122). The tail may become closer to the POI (e.g., the sensor 122) as the apparatus 102 navigates itself closer to the POI (e.g., the sensor 122) using the propellers 104-107.

Although also not illustrated in FIG. 1, in some configurations, the extension portion 116 may have a fixed length. An extension portion 116 that has a fixed length may exist in various forms, types, configurations, and arrangements without deviating from the scope of the present disclosure. Generally, the extension portion 116 may be characterized as rigid if one or more of the dimensions (e.g., length, width, height, etc.) of the extension portion 116 are constant. In some aspects, the extension portion 116 may be directed, angled, pointed, or otherwise moved in one or more trajectories. For instance, the extension portion 116 may be fixed in length but directed, angled, pointed, or otherwise moved in the trajectory of the POI. The extension portion 116 may be directed, angled, pointed, or otherwise moved in a downward trajectory towards the location of the POI (e.g., the sensor 122) during a first period of time (e.g., during a period of time when the sensor 122 is being powered and data being collected) and subsequently directed, angled, pointed, or otherwise moved away from the location of the POI (e.g., the sensor 122) during a second period of time (e.g., during a period of time when the apparatus 102 is traveling from one sensor 122 to another sensor 123).

In some other configurations, the extension portion 116 is not fixed in length. Accordingly, the length of the extension portion 116 may be adjusted. An extension portion 116 that has an adjustable length may exist in various forms, types, configurations, and arrangements without deviating from the scope of the present disclosure. Generally, the extension portion 116 can be characterized as adjustable if one or more dimensions (e.g., length, width, height, etc.) of the extension portion 116 are configured to increase and/or decrease. More specifically, the extension portion 116 can be characterized as adjustable if one or more dimensions of the extension portion 116 are configured to increase and/or decrease towards or away from the POI (e.g., the sensor 122). The length of the extension portion 116 may be adjusted utilizing various mechanisms without deviating from the scope of the present disclosure. The extension portion 116 may be extended or retracted in various trajectories without deviating from the scope of the present disclosure. In some aspects, the extension portion 116 may be adjusted by extended towards and/or retracted from the POI (e.g., the sensor 122). Accordingly, the extension portion 116 may provide the means for extending towards the POI (e.g., the sensor 122). In some configurations, the extension portion 116 is adjusted utilizing a reel 110, as described in greater detail below.

In various configurations, the extension portion 116 of the apparatus 102 may be extended (e.g., downwards, horizontally, or any other suitable direction) utilizing many techniques without deviating from the scope of the present disclosure. Generally, extending the extension portion 116 may involve drawing out, unreeling, unfolding, folding out, angling outwards, rotating outwards, gliding outwards, spiraling outward, unwinding, and/or otherwise moving at least a part of the extension portion 116 towards a particular area (e.g., the POI, such as the sensor 122). One of ordinary skill in the art will understand that the extension portion 116 may be extended using various techniques without deviating from the scope of the present disclosure. However, any technique that can be utilized to extend (e.g., downward, horizontally, or any other suitable direction) the extension portion 116 of the apparatus 102 is within the scope of the present disclosure. Although non-limiting examples of such techniques may be described herein, one of ordinary skill in the art will understand that various other techniques may be utilized without deviating from the scope of the present disclosure.

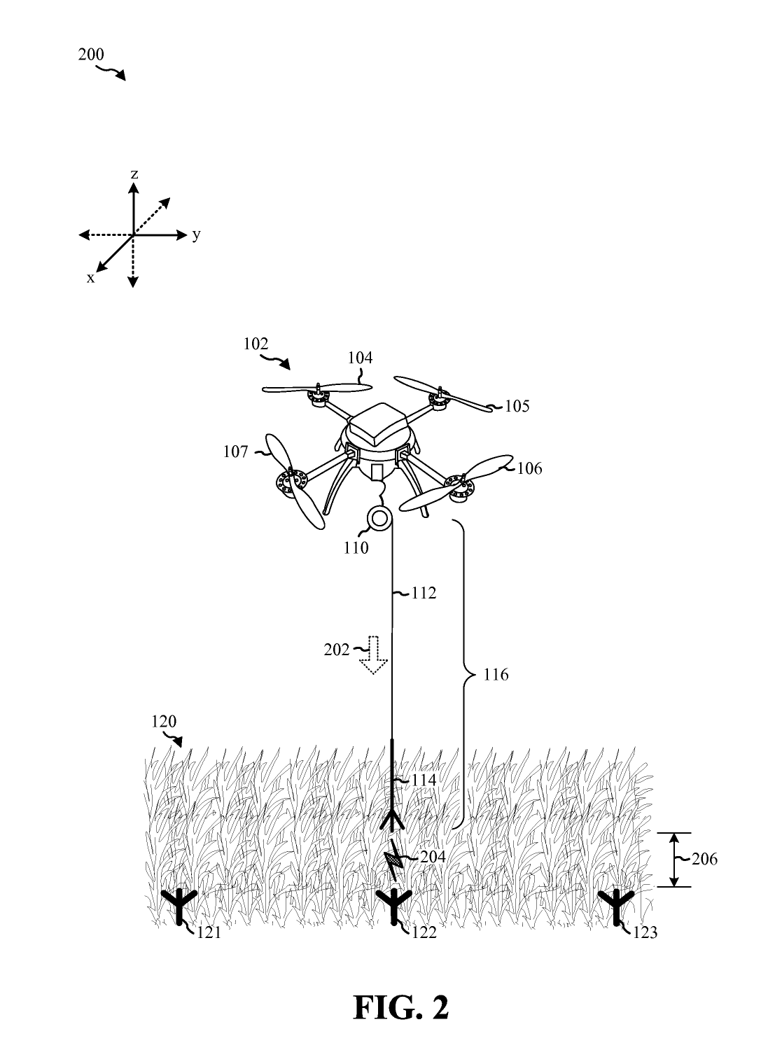

An example of such a technique may utilize a reel 110. Generally, a reel 110 is an object around which another material (e.g., the retractable transmission line 112) is wound. For instance, the reel 110 may have a cylindrical core and walls on the sides to retain the material wound around the cylindrical core. The reel 110 may turn, spin, or rotate in a first direction that causes the material (e.g., the retractable transmission line 112) to become wound around the core of the reel 110. The reel 110 may also turn, spin, or rotate in a second direction (different from the first direction) that causes the material (e.g., the retractable transmission line 112) to become unwound from the core of the reel 110. The reel 110 may be configured to extend and retract the retractable transmission line 112 such that the antenna 114 is lowered and raised, respectively, thereby adjusting the length of the extension portion 116. The reel 110 may be controlled or moved by any type of mechanism without deviating from the scope of the present disclosure. For example, the reel 110 may be controlled or moved by a mechanical motor, an electric motor, or any other suitable type of motor. In some configurations, the reel 110 may include a pulley, a wheel, a wheel with a grooved rim and/or flange, or any other suitable component configured for extending and retracting the retractable transmission line 112. The antenna 114 may be configured to transmit and receive various data signals and/or power signals, as described further below with reference to FIG. 2. As mentioned above, the apparatus 102 may move to a position that is in proximity to a particular POI. In the example illustrated in FIG. 1, the POI corresponds to the location of the sensor 122. The apparatus 102 may move to a position that is in proximity to the sensor 122 in order to obtain data from that sensor 122. The sensor 122 may be configured to measure and eventually transmit various types of information to the apparatus 102 without deviating from the scope of the present disclosure. Sensors may measure various parameters pertaining to environmental conditions. For example, such sensors may measure temperature, air moisture, radioactivity, smoke, heat, luminosity, pressure, soil moisture, infrared data, various chemicals, various types of images, etc. In some configurations, the sensor 122 may be a ‘sensor package,’ which is a device able to measure parameters corresponding to more than one environmental condition. For example, the sensor package may be a single device that is able to measure parameters corresponding to air moisture, airborne chemicals, air pressure, and air temperature. Although not a limitation of the present disclosure, sensors may be utilized in agricultural applications. Sensors may also be used in non-agricultural applications. Non-limiting examples of non-agricultural applications may include infrastructure, forestry, manufacturing, airports, shipping ports, land surveying, mines, construction sites, wildlife research, prospecting, storm tracking, weather forecasting, emergency response, environmental monitoring, search and rescue, and various other non-agricultural applications. In agricultural applications, sensors may be placed on or inserted into the soil where agricultural products are grown and harvested. Growers of agricultural products may utilize information gathered from such sensors to control irrigation, fertilization, and other growing conditions.

In some circumstances, such sensors (e.g., sensors 121-123) may be located throughout an area that does not provide a reliable source of power. For example, the sensors 121-123 may be distributed throughout a large agricultural field (e.g., tens or hundreds of acres). Providing power to the sensors 121-123 in a large agricultural field may be cost-prohibitive and/or labor-intensive. A conventional approach to providing power to the sensors 121-123 may include running a network of wires throughout the large agricultural field. However, running a network of electrical wires throughout a large agricultural field can be expensive. Also, repair and maintenance on those wires can be costly. Another conventional approach to providing power to the sensors 121-123 may involve the use of solar cells. However, solar cells may be unable to provide a reliable source of power to the sensors 121-123 due to the unpredictable nature of weather conditions. For example, rainy, cloudy, and snowy days may not offer sufficient sunlight to the solar cells to reliably power the sensors 121-123. Also, the agricultural plants 120 may block or interfere with the emanation of sunlight to the sensors. Further, repair and maintenance of those solar cells can be expensive. Accordingly, conventional approaches to powering such sensors 121-123 have certain limitations.

Accordingly to various aspects of the present disclosure, the sensors 121-123 may be able to receive power using the apparatus 102. For example, the sensors 121-123 may receive power through the extension portion 116 of the apparatus 102. The extension portion 116 of the apparatus 102 may provide power to the sensors 121-123 utilizing various technologies without deviating from the scope of the present disclosure. In some configurations, the apparatus 102 may provide power to the sensors 121-123 utilizing a wired connection. A wired connection refers to a physical coupling between a portion of a sensor 122 and a portion of the extension portion 116. In other words, the distal part (e.g., the antenna 114) of the extension portion 116 may be configured to couple to the sensor 122. After coupling to the sensor 122, the distal part (e.g., the antenna 114) of the extension portion 116 may be further configured to provide power to the sensor 122 via a wired connection, and receive data from the sensor 122 via a wired connection. In configurations wherein a wired connection is formed between a portion (e.g., the antenna 114) of the extension portion 116 and the sensor 122, a portion of the sensor 122 and/or a portion of the extension portion 116 may include an attractant. Generally, an attractant refers to a substance that induces an attraction to something else. A non-limiting example of an attractant is a magnet. For example, a top portion of the sensor 122 may include a magnet and/or a bottom portion of the extension portion 116 may include a magnet. The attractant(s) may be configured to facilitate the wired connection between the sensor 122 and the extension portion 116.

In some other configurations, the apparatus 102 may provide power to the sensors 121-123 utilizing a wireless connection. For example, the distal part (e.g., the antenna 114) of the extension portion 116 may be configured to provide power to the sensor 122 via a wireless connection. The distal part (e.g., the antenna 114) of the extension portion 116 may also be configured to receive data from the sensor via a wireless connection. Various types of technologies may be implemented for wireless charging without deviating from the scope of the present disclosure. Regardless of the particular type of technology implemented, the distal part (e.g., the antenna 114) of the extension portion 116 of the apparatus 102 is likely required to be within a minimum distance relative to the sensors 121-123. In other words, the power attenuation of signals traveling through that distance 130 may need to be below a particular threshold. Power attenuation across agricultural plants 120 may sometimes be referred to as ‘foliage loss.’ Foliage loss can contribute to substantial power attenuation during the transmission of power signals from the antenna 114 to the sensor 122 as well as during the transmission of data signals from the sensor 122 to the antenna 114. Some mathematical models (e.g., FITU-R models) estimate that foliage loss across 2.5 meters (e.g., the average height of corn at a mature stage) may be approximately 7 dB at 900 MHz and approximately 10.2 dB at 2.4 GHz. Other mathematical models (e.g., COST235) estimate that foliage loss across 2.5 meters may be approximately 18.6 dB at 900 MHz and approximately 18.5 dB at 2.4 GHz. Accordingly, in some circumstances, the distance 130 separating the distal part (e.g., the antenna 114) of the extension portion 116 of the apparatus 102 and the sensor 122 may be too long to enable wireless charging of the sensor 122.

However, the apparatus 102 may be prohibited from lowering itself any more to reduce that distance 130. For example, the apparatus 102 may be an aerial drone that is prohibited from lowering itself any further for safety reasons. For instance, further lowering the apparatus 102 may substantially increase the likelihood of the apparatus 102 colliding with the agricultural plants 120. To reduce the distance 130 between the distal part (e.g., the antenna 114) of the extension portion 116 and the sensor 122 without further lowering the apparatus 102, the extension portion 116 may be extended towards the sensor 122, as further described below with reference to FIG. 2.

FIG. 2 is a diagram 200 illustrating an example of the apparatus 102 with the extension portion 116 extended towards the POI (e.g., the sensor 122). One of ordinary skill in the art will understand that the extension portion 116 may extend or be moved using various techniques without deviating from the scope of the present disclosure. In the non-limiting example illustrated in FIG. 2, the extension portion 116 is moved further towards the POI (e.g., the sensor 122) after positioning the apparatus 102 in proximity to the POI (e.g., the sensor 122). The extension portion 116 is moved by utilizing the reel 110 to extend the length of the retractable transmission line 112 in a downward direction 202 towards the sensor 122. In configurations wherein a wired connection is formed between the extension portion 116 and the sensor 122, the retractable transmission line 112 is extended until a physical connection is formed between the sensor 122 and the extension portion 116. In configurations wherein a wireless connection 204 is formed between the extension portion 116 and the sensor 122, the retractable transmission line 112 is extended until the distance 206 separating the sensor 122 and the extension portion 116 is equal to or less than the minimum distance required for a wireless connection 204 according to the particular technology implemented. One of ordinary skill in the art will readily be able to determine the appropriate distance 206 required based on the particular implementation utilized.

In some configurations, a relationship exists between the length of the extension portion 116 and the length of an obstruction near the POI. For example, the length of the extension portion 116 of the apparatus 102 may be at least as long as the length of an object preventing the apparatus 102 from positioning closer to the POI. Referring to FIG. 2, the length of the extension portion 116 of the apparatus 102 is at least as long as the height of the agricultural plants 120 that are preventing the apparatus 102 from lowering itself further to be closer to the sensor 122. In other words, the length of the extension portion 116 is longer than the height of the agricultural plants 120. Without the extension portion 116 having such a length, the apparatus 102 may not be able to reach the sensor 122. Accordingly, the extension portion 116 provides an advantage to the apparatus 102 for reaching the POI (e.g., the sensor 122).

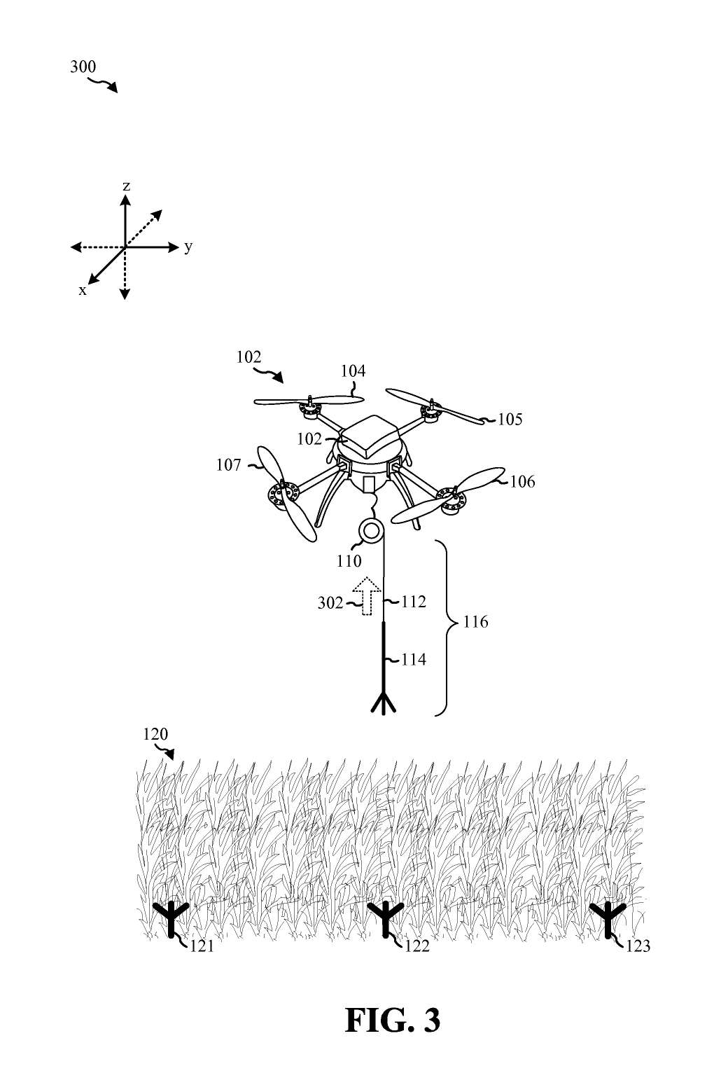

After the extension portion 116 is lowered towards the sensor 122, the apparatus 102 may provide power to the sensor via the extension portion 116. By providing power to the sensor 122, the sensor 122 may be energized to perform various operations pertaining to making various measurements. Various non-limiting examples of sensors are described above and therefore will not be repeated. Subsequently, the sensor 122 may transmit data pertaining to those measurements to the extension portion 116 of the apparatus 102. For example, the data from the sensor 122 may be received by the antenna 114 of the extension portion 116. As described above, the connectivity between the sensor 122 and the extension portion 116 may be wired and/or wireless without deviating from the scope of the present disclosure. Eventually, in some configurations, the apparatus 102 may retract the extension portion 116, as further described below with reference to FIG. 3.

FIG. 3 is a diagram 300 illustrating an example of the apparatus 102 with the extension portion 116 retracting away from the POI (e.g., the sensor 122). Generally, retracting the extension portion 116 may be characterized as drawing in, withdrawing, pulling back, reeling in, extracting, folding up, folding in, angling inwards, rotating inwards, gliding inwards, and/or otherwise moving at least a portion of the extension portion 116 away from a particular area (e.g., the POI, such as the sensor 122). One of ordinary skill in the art will understand that the extension portion 116 may be retracted using various techniques without deviating from the scope of the present disclosure. In the non-limiting example illustrated in FIG. 3, the extension portion 116 is retracted by utilizing the reel 110 to retract the retractable transmission line 112 in an upwards direction 302 away from the sensor 122. In another example, the extension portion 116 may include hinges that allow sub-portions of the extension portion 116 to fold onto each other, thereby moving at least a portion of the extension portion 116 away from the POI (e.g., the sensor 122). In yet another example, the extension portion 116 may include many sub-portions that glide onto or into one another in a manner that moves at least a portion of the extension portion 116 away from POI (e.g., the sensor 122). In a further example, the extension portion 116 may be rigid, and the rigid extension portion 116 may be retracted by angling or rotating at least a segment of the extension portion 116 away from the POI (e.g., the sensor 122). The extension portion 116 may be retracted for various reasons without deviating from the scope of the present disclosure. In some circumstances, the extension portion 116 may be retracted for safety reasons. For instance, if the extension portion 116 is not sufficiently retracted, a portion of the extension portion 116 may contact a portion of the agricultural plants 120, which may result in problems during aviation.

The apparatus 102 may retract the extension portion 116 based on various parameters without deviating from the scope of the present disclosure. In some configurations, the apparatus 102 may retract the extension portion 116 after receiving the data from the sensor 122. In some other configurations, the apparatus 102 may retract the extension portion 116 after expiration of a time period during which no data is received from the sensor 122. For example, in some circumstances, the sensor 122 may be inoperable and therefore not transmitting data. After waiting for a period of time, the apparatus 102 may retract the extension portion 116 and possibly move to another sensor (e.g., the adjacent sensor 123). By moving to another sensor (e.g., the adjacent sensor 123), the apparatus 102 minimizes the likelihood of wasting time and power on attempting to collect data from a sensor (e.g., the sensor 122) that is inoperable.

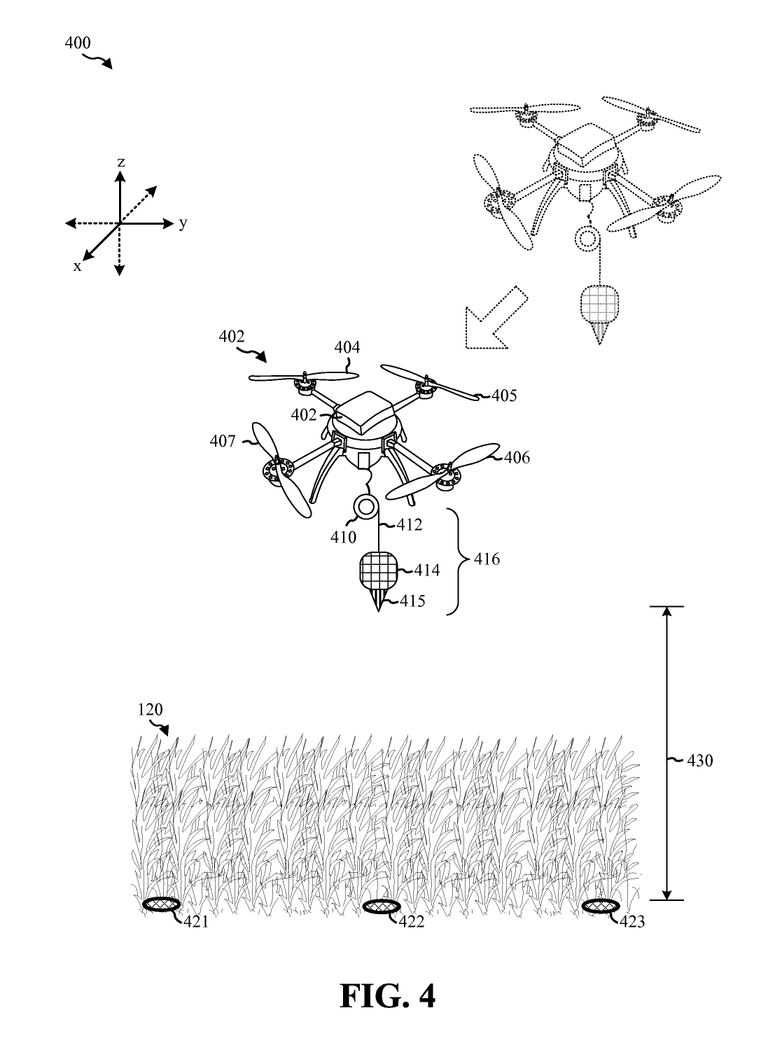

FIG. 4 is a diagram 400 illustrating another example of an apparatus 402 moving to a position in proximity to a POI. Various aspects pertaining to the POI is described in greater detail above and therefore will not be repeated. In the non-limiting example illustrated in FIG. 4, the POI is a particular location 422. Generally, the apparatus 402 may be any device that is configured to move in proximity to another object (e.g., a POI, such as the location 422). For purposes of illustration and not limitation, FIG. 4 shows that such an apparatus 402 may be an aerial drone. However, one of ordinary skill in the art will understand that the apparatus 402 may be a non-aerial drone without deviating from the scope of the present disclosure. For example, the apparatus 402 may be a terrestrial drone. The terrestrial drone may be configured to move to a position that is in proximity to the POI (e.g., the location 422) by moving towards that POI (e.g., the location 422) and positioning itself near that POI (e.g., the location 422). For example, the terrestrial drone may be configured to be sufficiently close to that POI (e.g., the location 422) such that its extension portion can reach that POI (e.g., the location 422). In some configurations, the apparatus 402 is an autonomous drone, which includes software and/or hardware modules that enables the apparatus 402 to control its own movements without relying upon constant control and navigation instructions from a user. For instance, an autonomous drone may be configured to locate the POI (e.g., the location 422) and navigate itself such that it is positioned in proximity to that POI. In some configurations, the apparatus 402 may be an aquatic drone. Various aspects pertaining to a drone (generally), an aerial drone, a terrestrial drone, an aquatic drone, and/or an autonomous drone described above with reference to FIGS. 1-3 are similar to a drone (generally), an aerial drone, a terrestrial drone, an aquatic, and/or an autonomous drone described with reference to FIGS. 4-6 and, therefore, the description of such similar features will not be repeated.

The apparatus 402 may include various components configured for moving the apparatus 402. The apparatus 402 may include a body that includes a processing system and/or a power source. The processing system, which is further described below with reference to FIG. 8, may provide the means for processing various data (e.g., data received from one or more sensors). The power source may be a battery, a solar cell, an electric generator, or any other suitable component that provides power. The power source may provide the means for powering (e.g., means for powering one or more sensors). The apparatus 402 may include a motor that controls the movement of the propellers 404-407 and thus the apparatus 402. The motor may be mechanical, electric, or any other suitable type of motor. The motor may provide the means for positioning the apparatus in proximity to a POI. Various aspects pertaining to the propellers 404-407 of the apparatus 402 is described in greater detail above with reference to the propellers 104-107 of FIG. 1 and therefore will not be repeated. One of ordinary skill in the art will understand that the apparatus 402 may include various components for movement without deviating from the scope of the present disclosure. For example, the apparatus 402 may include a fixed-wing, wherein the fixed-wing may be configured to assist the apparatus 402 with gliding and turning in the air. As another example, the apparatus 402 may be terrestrial and include one of many types of motor engines, which may be powered by gasoline, diesel, bio-fuels, and/or electric power generated by solar-based power generator and/or wind-based power generators. One of ordinary skill in the art understands that that apparatus 402 may include various components configured for moving the apparatus 402 without deviating from the scope of the present disclosure.

The apparatus 402 may also include an extension portion 416. The extension portion 416 may exist in various forms, types, configurations, and arrangements without deviating from the scope of the present disclosure. Any description herein with regard to the extension portion 416 of the apparatus 402 is provided for illustrative purposes and shall not be construed excluding alternative forms, types, configurations, and arrangements of the extension portion 416 of the apparatus 402. In the example illustrated in FIG. 4, the extension portion 416 of the apparatus 402 includes a sensor 414 at a distal part of a retractable transmission line 112. The retractable transmission line 412 may include a power line configured for providing power from the power source (as described above) of the apparatus 402 to a distal part (e.g., the sensor 414) of the extension portion 416. The retractable transmission line 412 may also include a communication line configured for communicating data from the distal part (e.g., the sensor 414) of the extension portion 416 to the processing system of the apparatus 402. In some configurations, the sensor 414 may also include a submergible portion 415, which is configured to be submerged below ground. For example, the submergible portion 415 may have a pointed or angled end region that facilitates its submersion into soil. Although not illustrated in FIG. 4, in some configurations, the extension portion 416 has a fixed length. In such configurations, the extension portion 416 may be fixed in a particular direction (e.g., downwards, towards the location of the POI). In some other configurations, the extension portion 416 is not fixed in length. Accordingly, the length of the extension portion 416 may be adjusted. The extension portion 416 may provide the means for extending towards the POI (e.g., the location 422). Various features of the extension portion 416 described with reference to FIGS. 4-6 may be similar to the features of the extension portion 116 described with reference to FIGS. 1-3 and, therefore, the description of such similar features will not be repeated. In the non-limiting example illustrated in FIG. 4, the extension portion 416 includes a reel 410. The reel 410 may be configured to extend and retract the retractable transmission line 412 such that the sensor 414 is lowered and raised, respectively, thereby adjusting the length of the extension portion 416. Various features of the reel 410 described with reference to FIGS. 4-6 may be similar to the features of the reel 110 described with reference to FIGS. 1-3 and, therefore, the description of such similar features will not be repeated.

As mentioned above, the apparatus 402 may move to a position that is in proximity to a particular POI. In the example illustrated in FIG. 4, the POI corresponds to the location 422. Sensors may measure various parameters pertaining to environmental conditions. For example, such sensors may measure temperature, air moisture, radioactivity, smoke, heat, luminosity, pressure, soil moisture, infrared data, various chemicals, various types of images, etc. In some configurations, the sensor 414 may be a ‘sensor package,’ which is a device able to measure parameters corresponding to more than one environmental condition. For example, the sensor package may be a single device that is able to measure parameters corresponding to air moisture, airborne chemicals, air pressure, and air temperature. In some circumstances, the sensor 414 may be used in agricultural applications. The sensor 414 may also be used in non-agricultural applications. In agricultural applications, the sensor 414 may be placed on or inserted into the soil where agricultural products are grown and harvested, e.g., utilizing the submergible portion 415. Growers of agricultural products may utilize information gathered from such sensors to control irrigation, fertilization, and other growing conditions.

As mentioned above, conventional systems for measuring environmental conditions may utilize various sensors deployed throughout a large geographic area (e.g., tens or hundreds of acres) using wires, batteries, and/or solar cells. However, for at least the reasons provided above, such conventional systems may be cost-prohibitive and labor-intensive in certain applications. Aspects of the present disclosure provide advantages over conventional systems for obtaining data from sensor, especially sensors located throughout a large geographic area. Firstly, because the sensor 414 is connected to the apparatus 402, the sensor 414 is provided with a reliable source of power from the apparatus 402. Secondly, because the sensor 414 is connected to the apparatus 402, the sensor 414 is provided with a reliable connection through which sensor data can be transmitted from the sensor 414 to the apparatus 402. Thirdly, because the sensor is connected to the apparatus 402, additional sensors are not required to be distributed throughout that large geographic area, which reduces material costs. Aspects of the present disclosure provide various other advantages readily appreciated by one of ordinary skill in the art.

In some circumstances, the sensor 414 may need to measure certain parameters that are lower in elevation than the elevation of the apparatus 402. For example, the sensor 414 may need to measure certain parameters at one of the locations 421-423 near the ground or soil. However, such parameters may not be reliably and/or accurately measured from a particular distance 430. As described above, foliage loss can contribute to substantial signal attenuation. The effects of foliage loss are described in greater detail above and therefore will not be repeated. Nevertheless, in some circumstances, the distance 430 separating the sensor 414 and the POI (e.g., the location 422) may be too long to enable reliable and/or accurate measurements.

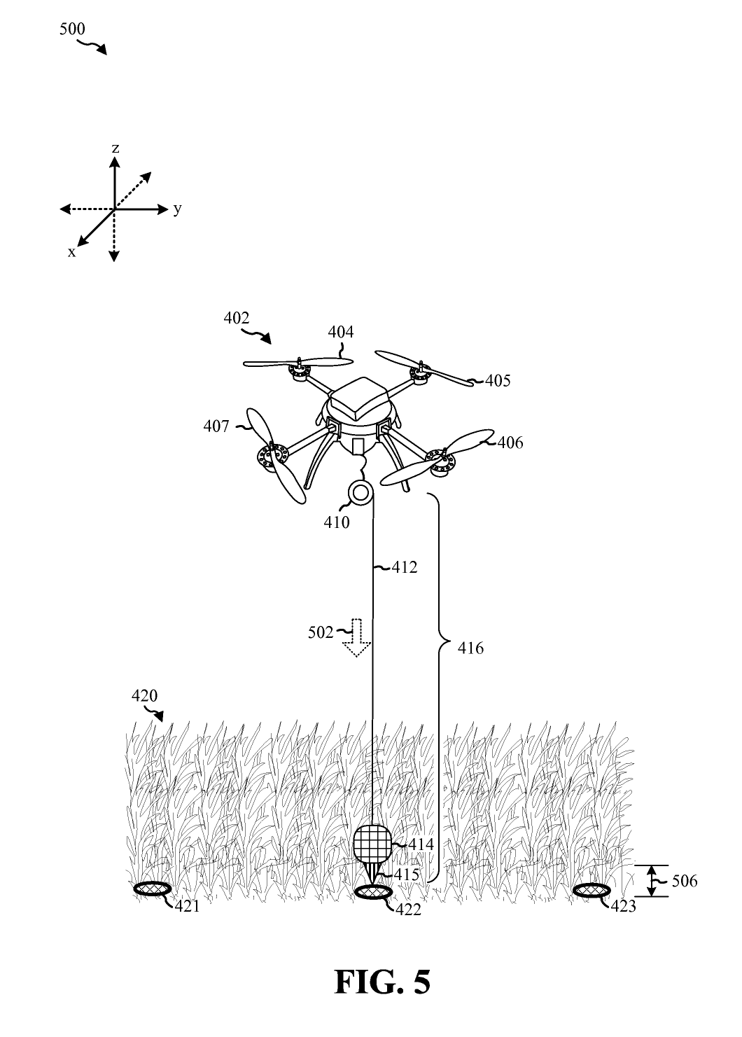

However, the apparatus 402 may be prohibited from lowering itself any more to reduce that distance 430. For example, the apparatus 402 may be an aerial drone that is prohibited from lowering itself any further for safety reasons. For instance, further lowering the apparatus 402 may substantially increase the likelihood of the apparatus 402 colliding with the agricultural plants 120. To reduce the distance 430 between the sensor 414 and the location 422 without further lowering the apparatus 402, the extension portion 416 may be extended towards the POI (e.g., the location 422), as further described below with reference to FIG. 5.

FIG. 5 is a diagram 200 illustrating an example of the apparatus 402 with the extension portion 416 extended towards the POI (e.g., the location 422). One of ordinary skill in the art will understand that the extension portion 416 may be extend or be moved using various techniques without deviating from the scope of the present disclosure. In the non-limiting example illustrated in FIG. 5, the extension portion 416 is moved further towards the POI (e.g., the location 422) after positioning the apparatus 402 in proximity to the POI (e.g., the location 422). The extension portion 416 is moved by utilizing the reel 410 to extend the length of the retractable transmission line 412 in a downward direction 502 towards the POI (e.g., the location 422). For example, the retractable transmission line 112 is extended until the sensor 414 is within a minimum distance 506 in relation to that particular POI (e.g., the location 422). Sensors may vary with regard to the minimum distance 506 required for reliable and/or accurate measurements of various environmental conditions. For example, the minimum distance 506 for a sensor that measures air moisture at the POI (e.g., the location 422) may be less than the minimum distance 506 for a sensor that measures air temperature at that POI (e.g., the location 422). One of ordinary skill in the art will understand that various distances may be implemented based on specific implementations without deviating from the scope of the present disclosure.

In some configurations, a relationship exists between the length of the extension portion 416 and the length of an obstruction near the POI. For example, the length of the extension portion 416 of the apparatus 402 is at least as long as the length of an object preventing the apparatus 402 from positioning closer to the POI. Referring to FIG. 5, the length of the extension portion 416 of the apparatus 402 is at least as long as the height of the agricultural plants 120 that are preventing the apparatus 402 from lowering itself further to be closer to the location 422. In other words, the length of the extension portion 416 is longer than the height of the agricultural plants 120. Without the extension portion 416 having such a length, the apparatus 102 may not be able to position the sensor 414 in sufficiently close proximity to the POI (e.g., the location 422). Accordingly, the extension portion 416 provides an advantage to the apparatus 402 for reaching the POI (e.g., the location 422).

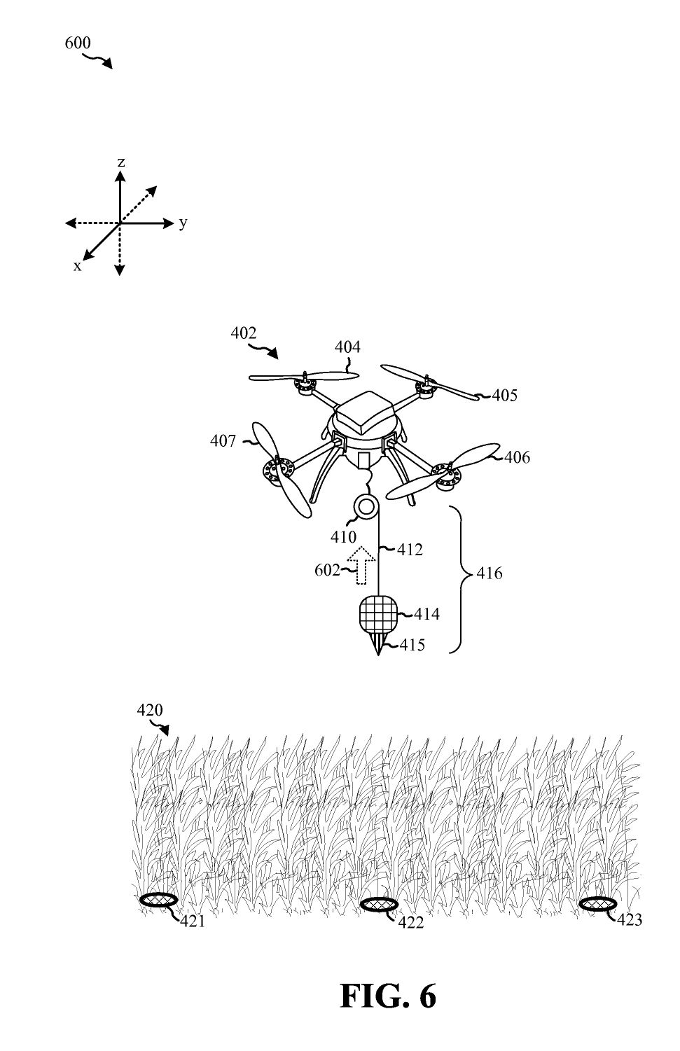

After the extension portion 416 is lowered towards the POI (e.g., the location 422), the apparatus 402 may provide power to the sensor 414 via the extension portion 416. By providing power to the sensor 414, the sensor 414 may be energized to perform various operations pertaining to making various measurements. Various non-limiting examples of sensors are described above and therefore will not be repeated. Subsequently, the sensor 414 may transmit data pertaining to those measurements to the apparatus 402. For example, the data from the sensor 414 may be transmitted via the retractable transmission line 412. Eventually, in some configurations, the apparatus 402 may retract the extension portion 416, as further described below with reference to FIG. 6.

FIG. 6 is a diagram 600 illustrating an example of the apparatus 402 with the extension portion 416 retracting away from the POI (e.g., the location 422). One of ordinary skill in the art will understand that the extension portion 416 may be retracted using various techniques without deviating from the scope of the present disclosure. In the non-limiting example illustrated in FIG. 6 the extension portion 416 is retracted by utilizing the reel 410 to reduce the length of the retractable transmission line 412 in an upwards direction 602 away from the POI (e.g., location 422). The extension portion 416 may be retracted for safety reasons. For example, if the extension portion 416 is not sufficiently retracted, a segment of the extension portion 416 may contact a portion of the agricultural plants 120, which may result in problems during aviation. The apparatus 402 may retract the extension portion 416 based on various parameters without deviating from the scope of the present disclosure. In some configurations, the apparatus 402 may retract the extension portion 416 after receiving the data from a sensor.

One of ordinary skill in the art will understand that sensors may be arranged in various configurations without deviating from the scope of the present disclosure. For example, each of the locations 421-423 may include a cluster of sensors. Generally, a cluster of sensors may refer to two or more sensors located in a common area or region. If one (or more) of the sensors in the cluster of sensors fails or becomes inoperable, the apparatus 102, 402 may utilize another one (or more) of the other sensors in the cluster of sensors. Without a cluster of sensors, the failure of a single sensor may result in the failure of data collection from the POI associated with that sensor. Further, waiting to replace or repair that sensor may delay data collection from the POI associated with that sensor. Even further, the costs associated with repairing a failed or inoperable sensor may be substantially higher than the cost of replacing or abandoning such that sensor. As described in greater detail above, some configurations of the apparatus 102, 402 may include a sensor package. Each sensor in the cluster of sensors may detect different conditions. For example, a first sensor of the cluster of sensors may detect soil temperature, and a second sensor of the cluster of sensors may detect air humidity. Accordingly, the sensor package may measure the soil temperature using the first sensor and concurrently or simultaneously measure air humidity using the second sensor.

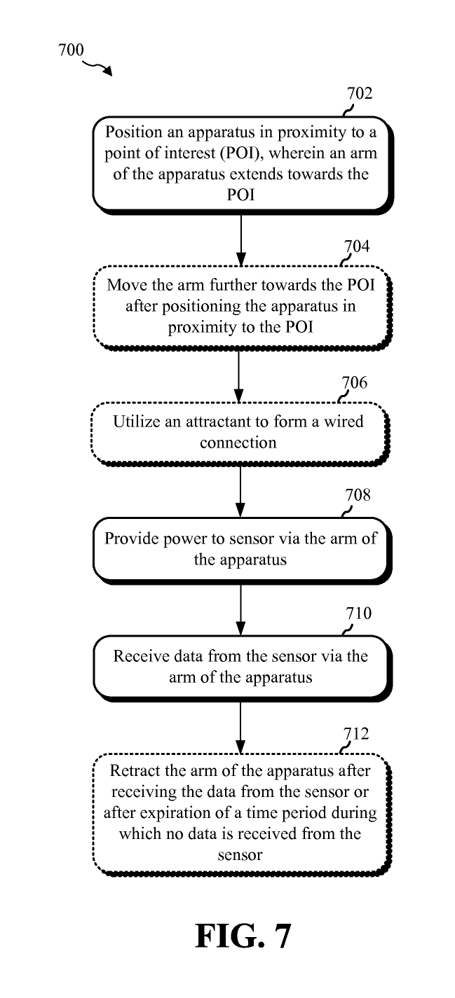

FIG. 7 is a diagram illustrating an example of various methods and/or processes operable at an apparatus. Such an apparatus may be the apparatus 102 described above with reference to FIGS. 1-3 and/or the apparatus 402 described above with reference to FIGS. 4-6. At block 702, the apparatus may position the apparatus in proximity to a POI, wherein an extension portion of the apparatus extends towards the POI. For example, referring to FIG. 1, the apparatus 102 determines to move to a position that is proximate to the sensor 122. As another example, referring to FIG. 4, the apparatus 402 determines to move to a position that is proximate to the location 422. In some configurations, the positioning the apparatus in proximity to the POI may include positioning the apparatus in proximity to a sensor located at the POI. For example, referring to FIG. 2, the apparatus 102 is positioned in proximity to the sensor 122, which is located at the POI. In some configurations, the positioning the apparatus in proximity to the POI may include at least partially submerging the sensor below ground. For example, referring to FIG. 5, the submergible portion 415 of the sensor 414 is at least partially submerged below ground.

In some configurations, at block 704, the apparatus may move the extension portion of the apparatus further towards the POI after positioning the apparatus in proximity to the POI. For example, referring to FIG. 2, the apparatus 102 may move the extension portion 116 further towards the POI (e.g., the sensor 122) after positioning the apparatus 102 in proximity to the POI (e.g., the sensor 122). The extension portion 116 is moved by utilizing the reel 110 to extend the length of the retractable transmission line 112 in a downward direction 202 towards the sensor 122. As another example, referring to FIG. 5, the apparatus 402 may move the extension portion 416 further towards the POI (e.g., the location 422) after positioning the apparatus 402 in proximity to the POI (e.g., the location 422). The extension portion 416 is moved by utilizing the reel 410 to extend the length of the retractable transmission line 412 in a downward direction 502 towards the location 422.

In some configurations, at block 706, the apparatus may utilize an attractant to form a wired connection between the extension portion of the apparatus and the sensor. The attractant may be located on at least one of the extension portion or the sensor. For example, referring to FIG. 2, the apparatus 102 may utilize an attractant (e.g., a magnet, an electromagnet, etc.) located on a portion of the extension portion 116 of the apparatus 102 and/or the sensor 122 to form a wired connection (not shown) between the extension portion 116 and the sensor. The data from the sensor 122 may be received by the extension portion 116 via that wired connection. The power to the sensor 122 may be provided by the extension portion 116 via that wired connection.

At block 708, the apparatus may provide power to a sensor via the extension portion of the apparatus. In some configurations, as illustrated in FIGS. 1-3, the sensor 122 is detached from the apparatus 102. In such configurations, the apparatus 102 may provide power to the sensor 122 via a wireless connection 204. Also in such configurations, although not illustrated in FIGS. 1-3, the apparatus 102 may provide power to the sensor 122 via a wired connection. As described in greater detail above, the extension portion 116 and/or the sensor 122 may include an attractant configured to facilitate forming the wired connection. In some other configurations, as illustrated in FIGS. 4-6, the sensor 414 is attached to the apparatus 402. For instance, the sensor 414 is attached to or included as a part of the extension portion 416 of the apparatus 402. As described in greater detail above, the sensor 414 may include a submergible portion 415, which is configured to be submerged below ground. As also described in greater detail above, the length of the extension portion 116, 416 of the apparatus 102, 402 may be at least as long as the length of an object (e.g., agricultural plants 120) preventing the apparatus 102, 402 from positioning closer to the POI (e.g., the sensor 122, the location 422).

At block 710, the apparatus may receive data from the sensor via the extension portion of the apparatus. In some configurations, as illustrated in FIGS. 1-3, the sensor 122 is detached from the apparatus 102. In such configurations, the apparatus 102 may determine to receive data from the sensor 122 via a wireless connection 204. Also in such configurations, although not illustrated in FIGS. 1-3, the apparatus 102 may receive data from the sensor 122 via a wired connection. As described in greater detail above, the extension portion 116 and/or the sensor 122 may include an attractant configured to facilitate forming the wired connection. In some other configurations, as illustrated in FIGS. 4-6, the sensor 414 is attached to the apparatus 402. For instance, the sensor 414 is attached or included as a part of the extension portion 416 of the apparatus 402. As described in greater detail above, the sensor 414 may include a submergible portion 415, which is configured to be submerged below ground. For example, the sensor 414 and/or the submergible portion 415 may be placed at, on, above, and/or underneath the POI (e.g., location 422). As also described in greater detail above, the length of the extension portion 116, 416 of the apparatus 102, 402 may be at least as long as the length of an object (e.g., agricultural plants 120) preventing the apparatus 102, 402 from positioning closer to the POI (e.g., the sensor 122, the location 422).

In some configurations, at block 712, the apparatus may retract the extension portion of the apparatus after receiving the data from the sensor or after expiration of a time period during which no data is received from the sensor. For example, referring to FIG. 3, the apparatus 102 may retract the extension portion 116 after expiration of a time period during which no data is received from the sensor 122. For example, in some circumstances, the sensor 122 may be inoperable and therefore not transmitting data. After waiting for a period of time, the apparatus 102 may retract the extension portion 116 and possibly move to another sensor (e.g., the adjacent sensor 123). By retracting the extension portion 116 and possibly moving to another sensor (e.g., the adjacent sensor 123), the apparatus 102 minimizes the likelihood of wasting time and power on attempting to collect data from a sensor that is inoperable.

The methods and/or processes described with reference to FIG. 7 are provided for illustrative purposes and are not intended to limit the scope of the present disclosure. The methods and/or processes described with reference to FIG. 7 may be performed in sequences different from those illustrated therein without deviating from the scope of the present disclosure. Additionally, some or all of the methods and/or processes described with reference to FIG. 7 may be performed individually and/or together without deviating from the scope of the present disclosure. It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

FIG. 8 is a diagram 800 illustrating an example of a hardware implementation of a processing system of an apparatus. Such an apparatus may be the same as or different from the apparatuses 102, 402 described above with reference to FIGS. 1-6 without deviating from the scope of the present disclosure. In some configurations, the processing system 802 may include a user interface 812. The user interface 812 may be configured to receive one or more inputs from a user of the processing system 802. The user interface 812 may also be configured to display information to the user of the processing system 802. The user interface 812 may exchange data to and/or from the processing system 802 via the bus interface 808. The processing system 802 may also include a transceiver 810. The transceiver 810 may be configured to receive data and/or transmit data in communication with another apparatus. The transceiver 810 provides a means for communicating with another apparatus via a wired and/or wireless transmission medium. The transceiver 810 may be configured to perform such communications using various types of technologies. One of ordinary skill in the art will understand that many types of technologies to perform such communication may be used without deviating from the scope of the present disclosure. The processing system 802 may also include a memory 814, one or more processors 804, a computer-readable medium 806, and a bus interface 808. The bus interface 808 may provide an interface between a bus 803 and the transceiver 810. The memory 814, the one or more processors 804, the computer-readable medium 806, and the bus interface 808 may be connected together via the bus 803. The processor 804 may be communicatively coupled to the transceiver 810 and/or the memory 814.

The processor 804 may include a positioning circuit 820, a power circuit 821, a sensor circuit 822, an extension circuit 823, and/or other circuits (not shown). Generally, the positioning circuit 820, the power circuit 821, the sensor circuit 822, the extension circuit 823, and/or other circuits (not shown) may, individually or collectively, include various hardware components and/or software modules that can perform and/or enable any one or more of the functions, methods, operations, processes, features and/or aspects described herein with reference to an apparatus. The positioning circuit 820 may be configured to determine to position an apparatus in proximity to the POI. In some configurations, the positioning circuit 820 may be configured to determine to position the apparatus in proximity to a sensor located at the POI. Such determinations may be performed according to various technologies, as described in greater detail above. Accordingly, the positioning circuit 820 provides a means for positioning an apparatus in proximity to the POI. In some configurations, the positioning circuit 820 may be configured to at least partially submerge a sensor below ground.

The power circuit 821 may be configured to determine to provide power to a sensor via the extension portion of the apparatus. In some configurations, the power circuit 821 may be configured to provide the power to the sensor via a wired connection and/or a wireless connection according to various parameters, as described in greater detail above. Accordingly, the power circuit 821 provides the means for providing power to a sensor via the extension portion of the apparatus.

The sensor circuit 822 may be configured to receive data from the sensor via the extension portion of the apparatus. Such reception may be performed utilizing the transceiver 810. In some configurations, the sensor circuit 822 may be configured to receive data from the sensor via the extension portion of the apparatus via a wired connection and/or a wireless connection according to various parameters, as described in greater detail above. Accordingly, the sensor circuit 822 provides the means for receiving data from the sensor via the extension portion of the apparatus. The extension circuit 823 may be configured to move, extend, and/or retract the extension portion of the apparatus in accordance with various aspects of the present disclosure. In some configurations, the extension circuit 823 may be configured to determine to move the extension portion of the apparatus further towards the POI after positioning the apparatus in proximity to the POI. In some configurations, the extension circuit 823 may be configured to utilize an attractant (e.g., a magnet) to form a wired connection between the extension portion of the apparatus and the sensor. In some configurations, the extension circuit 823 may be configured to determine to retract the extension portion of the apparatus after receiving the data from the sensor or after expiration of a time period during which no data is received from the sensor. Accordingly, the extension circuit 823 provides the means for retracting the extension portion of the apparatus in accordance to various aspects of the present disclosure.

The foregoing description provides a non-limiting example of the processor 804 of the processing system 802. Although various circuits have been described above, one of ordinary skill in the art will understand that the processor 804 may also include various other circuits (not shown) that are in addition and/or alternative(s) to circuits 820, 821, 822, 823. Such other circuits (not shown) may provide the means for performing any one or more of the functions, methods, operations, processes, features and/or aspects described herein with reference to the apparatus.

The computer-readable medium 806 includes various computer executable instructions. The computer-executable instructions may be executed by various hardware components (e.g., processor 804, or any one or more of its circuits 820, 821, 822, 823) of the processing system 802. The instructions may be a part of various software programs and/or software modules. The computer-readable medium 806 may include positioning instructions 840, power instructions 841, sensor instructions 842, extension instructions 843, and/or other instructions (not shown). Generally, the positioning instructions 840, the power instructions 841, the sensor instructions 842, the extension instructions 843, and/or the other instructions (not shown) may, individually or collectively, be configured for performing and/or enabling any one or more of the functions, methods, operations, processes, features and/or aspects described herein with reference to an apparatus.

The positioning instructions 840 may include computer-executable instructions configured for positioning an apparatus in proximity to the POI. In some configurations, the positioning instructions 840 may include computer-executable instructions configured for positioning the apparatus in proximity to a sensor located at the POI. Such determinations may be performed according to various technologies, as described in greater detail above. In some configurations, the positioning instructions 840 may include computer-executable instructions configured for at least partially submerging a sensor below ground. The power circuit 841 may include computer-executable instructions configured for providing power to a sensor via the extension portion of the apparatus. In some configurations, the power is provided to the sensor via a wired connection and/or a wireless connection according to various parameters, as described in greater detail above. The sensor instructions 842 may include computer-executable instructions configured for receiving data from the sensor via the extension portion of the apparatus. Such reception may be performed utilizing the transceiver 810. In some configurations, the data may be received from the sensor via the extension portion of the apparatus utilizing a wired connection and/or a wireless connection according to various parameters, as described in greater detail above. The extension instructions 843 may include computer-executable instructions configured for extending, moving, and/or retracting the extension portion of the apparatus in accordance with various aspects of the present disclosure. In some configurations, the extension instructions 843 may include computer-executable instructions configured for moving the extension portion of the apparatus further towards the POI after positioning the apparatus in proximity to the POI. In some configurations, the extension instructions 843 may include computer-executable instructions configured for utilizing an attractant (e.g., a magnet) to form a wired connection between the extension portion of the apparatus and the sensor. In some configurations, the extension instructions 843 may include computer-executable instructions configured for retracting the extension portion of the apparatus after receiving the data from the sensor or after expiration of a time period during which no data is received from the sensor.

The foregoing description provides a non-limiting example of the computer-readable medium 806 of the processing system 802. Although various computer-executable instructions (e.g., computer-executable code) have been described above, one of ordinary skill in the art will understand that the computer-readable medium 806 may also include various other instructions (not shown) that are in addition and/or alternative(s) to instructions 840, 841, 842, 843. Such other instructions (not shown) may include computer-executable instructions configured for performing any one or more of the functions, methods, processes, operations, features and/or aspects described herein with reference to an apparatus.

The memory 814 may include various memory modules. The memory modules may be configured to store, and have read therefrom, various values and/or information by the processor 804, or any of its circuits 820, 821, 822, 823. The memory modules may also be configured to store, and have read therefrom, various values and/or information upon execution of the computer-executable code included in the computer-readable medium 806, or any of its instructions 840, 841, 842, 843. In some configurations, the memory 814 may include location data 830. The location data 830 may include coordinates, positioning information, and/or other suitable data that can be used by the processor 804 (or, specifically, the positioning circuit 820) and/or the computer-readable medium 806 (or, specifically, the positioning instructions 840) to position the apparatus (e.g., apparatus 102, 402) in proximity to the POI (e.g., the sensor 122, the location 422). The memory 814 may also include sensor data 832. Sensor data 832 may include decoding, demodulation, processing parameters, and/or other suitable data that can be used by the processor 804 (or, specifically, the sensor circuit 822) and/or the computer-readable medium 806 (or, specifically, the sensor instructions 842) to receive and subsequently process the data from one or more sensors (e.g., sensor(s) 121-123, 141).

One of ordinary skill in the art will also understand that the processing system 802 may include alternative and/or additional elements without deviating from the scope of the present disclosure. In accordance with some aspects of the present disclosure, an element, or any portion of an element, or any combination of elements may be implemented with a processing system 802 that includes one or more processors 804. Examples of the one or more processors 804 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. The processing system 802 may be implemented with a bus architecture, represented generally by the bus 803 and bus interface 808. The bus 803 may include any number of interconnecting buses and bridges depending on the specific application of the processing system 802 and the overall design constraints. The bus 803 may link together various circuits including the one or more processors 804, the memory 814, and the computer-readable media 806. The bus 803 may also link various other circuits, such as timing sources, peripherals, voltage regulators, and power management circuits, which are well known in the art.

The one or more processors 804 may be responsible for managing the bus 803 and general processing, including the execution of software stored on the computer-readable medium 806. The software, when executed by the one or more processors 804, causes the processing system 802 to perform the various functions described below for any one or more apparatuses. The computer-readable medium 806 may also be used for storing data that is manipulated by the one or more processors 804 when executing software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 806. The computer-readable medium 806 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 806 may also include, by way of example, a carrier wave, a transmission line, and any other suitable medium for transmitting software and/or instructions that may be accessed and read by a computer. The computer-readable medium 806 may reside in the processing system 802, external to the processing system 802, or distributed across multiple entities including the processing system 802. The computer-readable medium 806 may be embodied in a computer program product. By way of example and not limitation, a computer program product may include a computer-readable medium in packaging materials. Those skilled in the art will recognize how best to implement the described functionality presented throughout this disclosure depending on the particular application and the overall design constraints imposed on the overall system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. For instance, a first die may be coupled to a second die in a package even though the first die is never directly physically in contact with the second die. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

The previous description is provided to enable any person skilled in the art to practice some aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of some aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of obtaining data, the method comprising:
positioning an apparatus in proximity to a point of interest (POI), wherein an extension portion of the apparatus extends towards the POI; and
providing power to a sensor via the extension portion of the apparatus; and
receiving data from the sensor via the extension portion of the apparatus.

2. The method of claim 1, wherein the positioning the apparatus in proximity to the POI comprises:
positioning the apparatus in proximity to the sensor located at the POI.

3. The method of claim 2, wherein:
the apparatus is detached from the sensor;
the receiving the data from the sensor comprises receiving the data from the sensor via a wireless connection between the extension portion of the apparatus and the sensor; and
the providing the power to the sensor comprises providing the power to the sensor via a wireless connection between the extension portion of the apparatus and the sensor.

4. The method of claim 2, wherein:
the receiving the data from the sensor comprises receiving the data from the sensor via a wired connection between the extension portion of the apparatus and the sensor; and
the providing the power to the sensor comprises providing the power to the sensor via a wired connection between the extension portion of the apparatus and the sensor.

5. The method of claim 4, further comprising:
utilizing an attractant to form the wired connection, wherein the attractant is located on at least one of the extension portion or the sensor.

6. The method of claim 1, wherein the sensor is attached to the extension portion of the apparatus.

7. The method of claim 6, wherein the positioning the apparatus in proximity to the POI comprises:
at least partially submerging the sensor below ground.

8. The method of claim 1, further comprising:
moving the extension portion of the apparatus further towards the POI after positioning the apparatus in proximity to the POI.

9. The method of claim 1, wherein a length of the extension portion of the apparatus is at least as long as a length of an object preventing the apparatus from positioning closer to the POI.

10. The method of claim 1, further comprising:
retracting the extension portion of the apparatus after receiving the data from the sensor or after expiration of a time period during which no data is received from the sensor.

11. The method of claim 1, wherein the method is performed by an autonomous drone or an apparatus configured to communicate with the autonomous drone.

12. An apparatus for obtaining data, the apparatus comprising:
a transceiver;
a memory; and
at least one processor communicatively coupled to the transceiver and the memory, wherein the at least one processor is configured to:
determine to position the apparatus in proximity to a point of interest (POI), wherein an extension portion of the apparatus extends towards the POI; and
utilize the transceiver to receive data from a sensor via the extension portion of the apparatus.

13. The apparatus of claim 12, wherein the apparatus further comprises a power source communicatively coupled to the at least one processor, wherein the at least one processor is configured to utilize the power source to provide power to the sensor via the extension portion of the apparatus.

14. The apparatus of claim 13, wherein the sensor is located at the POI.

15. The apparatus of claim 14, wherein:
the apparatus is detached from the sensor;
the transceiver receives the data from the sensor via a wireless connection between the extension portion of the apparatus and the sensor; and
the power source provides the power to the sensor via a wireless connection between the extension portion of the apparatus and the sensor.

16. The apparatus of claim 14, wherein:
the transceiver receives the data from the sensor via a wired connection between the extension portion of the apparatus and the sensor;
the power source provides the power to the sensor via a wired connection between the extension portion of the apparatus and the sensor; and
at least one of the extension portion or the sensor comprises an attractant configured to facilitate forming the wired connection.

17. The apparatus of claim 12, wherein the sensor is attached to the extension portion of the apparatus, and wherein the sensor is configured to be at least partially submerged below ground.

18. The apparatus of claim 12, wherein the at least one processor is further configured to:
determine to move the extension portion of the apparatus further towards the POI after positioning the apparatus in proximity to the POI.

19. The apparatus of claim 12, wherein a length of the extension portion of the apparatus is at least as long as a length of an object preventing the apparatus from positioning closer to the POI.

20. The apparatus of claim 12, wherein the at least one processor is further configured to:
determine to retract the extension portion of the apparatus after receiving the data from the sensor or after expiration of a time period during which no data is received from the sensor.

21. The apparatus of claim 12, wherein the apparatus is located in an autonomous drone or in an apparatus configured to communicate with the autonomous drone.

22. An apparatus for obtaining data, the apparatus comprising:
a processing system;
a motor for positioning the apparatus in proximity to a POI; and
an extension portion extending towards the POI, wherein the extension portion comprises:
a power line configured for providing power to a distal part of the extension portion; and
a communication line configured for communicating data from the distal part of the extension portion to the processing system.

23. The apparatus of claim 22, wherein the apparatus is detached from a sensor, and wherein the distal part of the extension portion is configured to:
provide the power to the sensor via a wireless connection; and
receive the data from the sensor via the wireless connection.

24. The apparatus of claim 22, wherein the distal part of the extension portion is configured to:
couple to a sensor;
provide the power to the sensor via a wired connection; and
receive the data from the sensor via the wired connection.

25. The apparatus of claim 24, wherein at least one of the distal part of the extension portion or the sensor comprises an attractant configured to facilitate the coupling of the sensor and the distal part of the extension portion.

26. The apparatus of claim 22, further comprising a sensor coupled to the distal part of the extension portion, wherein the power is provided to the sensor via the power line, and wherein the data is communicated from the sensor to the processing system via the communication line.

27. The apparatus of claim 22, wherein the extension portion is configured to:
move further towards the POI after the apparatus is positioned in proximity to the POI.

28. The apparatus of claim 22, wherein a length of the extension portion of the apparatus is at least as long as a length of an object preventing the apparatus from positioning closer to the POI.

29. The apparatus of claim 22, wherein the extension portion is configured to:
retract after the data is communicated from a sensor to the processing system or after expiration of a time period during which no data is communicated from the sensor to the processing system.

30. An apparatus for obtaining data, the apparatus comprising:
means for processing;
means for positioning the apparatus in proximity to a POI; and
means for extending towards the POI, wherein the means for extending towards the POI comprises:
a power line configured for providing power to a distal part of the means for extending towards the POI; and
a communication line configured for communicating data from the distal part of the means for extending towards the POI to the means for processing.
